(19) United States
(12) Patent Application Publication
(10) Pub. No.: US 2006/0246253 A1
(43) Pub. Date: Nov. 2, 2006

(54) Optical recording material, optical recording material solution, optical recording medium, and method of manufacturing the same

(75) Inventors: Masahiro Shinkai, Tokyo (JP); Junji Tanabe, Tokyo (JP); Atsushi Monden, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/405,498

(22) Filed: Apr. 18, 2006

(30) Foreign Application Priority Data
Apr. 28, 2005 (JP) 2005-132549

(51) Int. Cl. B32B 3/02

(52) U.S. Cl. 428/64.4

(57) ABSTRACT

An optical recording material for an optical recording medium capable of recording information by irradiation of light including: a cation represented by the following general formula (1); and a chelate compound formed by an azo compound and a metal,

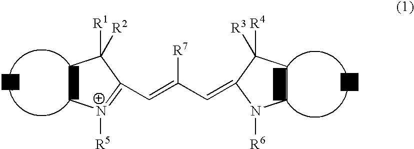

wherein at least one of R¹, R², R³ and R⁴ is an optionally substituted benzyl group, and at least one of R⁵ and R⁶ is an optionally substituted alkyl group having a carbon number of at least 5 or an optionally substituted aryl group having a carbon number of at least 5.

### BACKGROUND OF THE INVENTION

1. Field of the Invention

The present invention relates to an optical recording material, an optical recording material solution, an optical recording medium, and a method of manufacturing the same.

2. Related Background Art

In general, optical recording media are manufactured by way of the steps of coating a substrate with an optical recording material solution in which an optical recording material containing a dye is dissolved in a solvent, and drying the optical recording material solution on the substrate.

The optical recording media have been shortening their recording and reproducing light wavelengths in order to further increase their recording density. For example, while the recording/reproducing wavelength of CD-R is currently at 780 nm, next-generation CD-R and DVD-R will shorten the wavelength to 635 to 680 nm. As dyes used in optical recording media adapted to respond to such short wavelength light, cyanine-based compounds and the like have already been known (Japanese Patent Application Laid-Open No. 2003-231359).

### SUMMARY OF THE INVENTION

The optical recording media have been required to respond to higher recording speeds as well as the shorter wavelength mentioned above. For a higher speed, it is desirable to use a dye having a higher sensitivity. However, dyes having a higher sensitivity tend to increase temporal fluctuations (jitter) in reproduced signals and lower optical stability (light resistance). For further increasing the speed from now on, it has been becoming hard for the conventional dyes to keep sufficiently satisfactory levels for favorable sensitivity, jitter, and optical stability at the same time.

In addition to required characteristics such as those mentioned above, optical recording materials have also been demanded to keep crystals derived therefrom from being precipitated for a period which is as long as possible when stored in the state of an optical recording material solution used for manufacturing an optical recording medium. If crystals are precipitated shortly after preparing an optical recording material solution by dissolving an optical recording material into a solvent, the amount of an optical recording material solution prepared at once must be made smaller, which lowers productivity. This also makes it harder to recycle the optical recording material solution. A crystal precipitated in the optical recording material solution, if any, causes a minute defect in the resulting optical recording medium and so forth, thereby remarkably lowering the yield of optical recording media in their manufacturing step.

In view of circumstances mentioned above, it is an object of the present invention to provide an optical recording material which exhibits sufficient levels of sensitivity, jitter, and optical stability at a high recording speed and suppresses crystallization in an optical recording material solution.

For achieving the above-mentioned object, an optical recording material for an optical recording medium capable of recording information by irradiation of light according to the present invention includes: a cation represented by the following general formula (1); and a chelate compound formed by an azo compound and a metal.

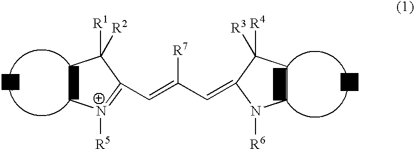

In the formula above, R¹, R², R³ and R⁴ each independently represent a C1-C4 alkyl group or an optionally substituted benzyl group; R⁵ and R⁶ each independently represent an optionally substituted alkyl group or an optionally substituted aryl group; R⁷ represents a hydrogen atom, a halogen atom, a cyano group, an optionally substituted alkyl group or an optionally substituted aryl group; and Q¹ and Q² each independently represent a group of atoms constituting an optionally substituted aromatic ring. Here, at least one of R¹, R², R³ and R⁴ is an optionally substituted benzyl group, R¹ and R² may form a ring structure by joining together, R³ and R⁴ may form a ring structure by joining together, and at least one of R⁵ and R⁶ is an optionally substituted alkyl group having a carbon number of at least 5 or an optionally substituted aryl group having a carbon number of at least 5.

By combining the specific compounds mentioned above, the optical recording material of the present invention exhibits sufficient levels of sensitivity, jitter, and optical stability at a high recording speed and suppresses crystallization in an optical recording material solution.

While in the state of a salt with a counterion, the cation represented by formula (1) constitutes a dye known as so-called cyanine-based dye. The inventors have found that an optical recording material exhibiting sufficient levels of sensitivity, jitter, and optical stability at a high recording speed is obtained when a chelate compound formed by an azo compound and a metal is used in combination with a cyanine-based cation having a benzyl group at a specific position. Further, the inventors have found that crystals are kept from being precipitated in an optical recording material solution for a sufficiently long period when the cyanine-based cation is one in which a nitrogen atom is substituted by an alkyl or aryl group having a carbon number of at least 5 in such a combination.

The optical recording material solution of the present invention comprises a solvent including fluorinated alcohol and the optical recording material according to the present invention dissolved in the solvent.

In the manufacture of optical recording media, an optical recording material solution employing fluorinated alcohol as a solvent has been used favorably, since it is suitably applied onto a polycarbonate substrate and so forth. When the cation is one having the above-mentioned specific substituent in an optical recording material solution in which an optical recording material containing the cyanine-based cation and the chelate compound, crystals are restrained from being precipitated for a sufficiently long period.

The method of manufacturing an optical recording medium in accordance with the present invention comprises the steps of forming a solution layer made of the optical recording material solution according to the present invention on a substrate, and removing the solvent from within the solution layer, so as to form a recording layer containing the optical recording material.

By using the optical recording material solution of the present invention, the method of manufacturing an optical recording medium can manufacture, with a sufficiently high production efficiency and a high yield, an optical recording medium which exhibits sufficient levels of sensitivity, jitter, and optical stability at a high recording speed.

The optical recording medium of the present invention comprises a recording layer containing the optical recording material of the present invention. Since the recording layer contains the optical recording material of the present invention, the optical recording material exhibits sufficient levels of sensitivity, jitter, and optical stability at a high recording speed. When the optical recording medium of the present invention is one obtained by the method of manufacturing an optical recording medium of the present invention, for example, its recording layer contains fluorinated alcohol.

### BRIEF DESCRIPTION OF THE DRAWINGS

FIG. 1 is a partly sectional view showing an embodiment of optical recording disk as the optical recording medium of the present invention.

FIG. 2 is a partly sectional view showing an embodiment of optical recording disk as the optical recording medium of the present invention.

### DESCRIPTION OF THE PREFERRED EMBODIMENTS

In the following, preferred embodiments of the present invention will be explained in detail. However, the present invention is not limited to the following embodiments.

Optical Recording Medium

The optical recording material of the present invention contains a cation (which may hereinafter be referred to as “cyanine dye cation”) represented by the above-mentioned formula (1) and a chelate compound formed by an azo compound and a metal. The cyanine dye cation and the chelate compound, which can separately act as dyes for optical recording, are used in combination in the present invention.

In the formula (1), R¹, R², R³ and R⁴ each independently represent a C1-C4 alkyl group or an optionally substituted benzyl group, whereas at least one of R¹, R², R³ and R⁴ is an optionally substituted benzyl group. R¹ and R² may form a ring structure by joining together, and R³ and R⁴ may form a ring structure by joining together.

When R¹, R², R³ or R⁴ is a C1-C4 alkyl group, it is preferably a methyl, ethyl or n-propyl group. When R¹, R², R³ or R⁴ is an optionally substituted benzyl group, it is preferably an unsubstituted benzyl group or a benzyl group whose phenyl group is substituted by a methyl group or halogen atom. When R¹ and R² or R³ and R⁴ form a ring structure by joining together, a cyclopropane ring, cyclobutane ring, cyclopentane ring or cyclohexane ring is preferably formed.

R⁵ and R⁶ each independently represent an optionally subsitituted alkyl group or an optionally substituted aryl group, whereas at least one of R⁵ and R⁶ is an optionally substituted alkyl group having a carbon number of at least 5 or an optionally substituted aryl group having a carbon number of at least 5. It will be preferred in particular if at least one of R⁵ and R⁶ is an alkyl group having a carbon number of at least 5, since the effect of suppressing crystal precipitation in the optical recording material solution is particularly enhanced thereby. Though the upper limit for the carbon number of R⁵ and R⁶ is appropriately determined such that characteristics such as heat resistance required for an optical recording material are not remarkably deteriorated thereby, at least one of R⁵ and R⁶ is preferably an optionally substituted alkyl group having a carbon number of 5 to 8 or an optionally substituted aryl group having a carbon number of 5 to 8.

More specifically, at least one of R⁵ and R⁶ is an n-pentyl group, an isopentyl group, a neopentyl group, a n-hexyl group, an isohexyl group, a n-heptyl group, a 5-methylhexyl group, a n-octyl group or a 3,4-dimethylpentyl group.

Among R⁵ and R⁶, a group other than the optionally substituted alkyl group having a carbon number of at least 5 or an optionally substituted aryl group having a carbon number of at least 5 is preferably an optionally substituted alkyl group having a carbon number of 1 to 4, more preferably a methyl or ethyl group.

R⁷ is a hydrogen atom, a halogen atom, a cyano group, an optionally substituted alkyl group or an optionally substituted aryl group. R⁷ is preferably a hydrogen atom, a halogen atom, a C1-C4 alkyl group, a cyano group, an optionally substituted phenyl group or an optionally substituted benzyl group. Among them, the hydrogen atom is preferred in particular.

Q¹ and Q² each independently represent a group of atoms constituting an optionally substituted aromatic ring. Q¹ and Q² are preferably a group of atoms which constitute an optionally substituted benzene group or an optionally substituted naphthalene ring. A substituent in the aromatic ring of Q₁ or Q₂ is preferably a methyl, ethyl, isopropyl, fluoro, chloro, bromo, methoxy, nitro or cyano group.

The cyanine dye cation is preferably a cation represented by the following general formula (1a), (1b), (1c), (1d), (1e), (1f), (1g), (1h), (1i), or (1j).

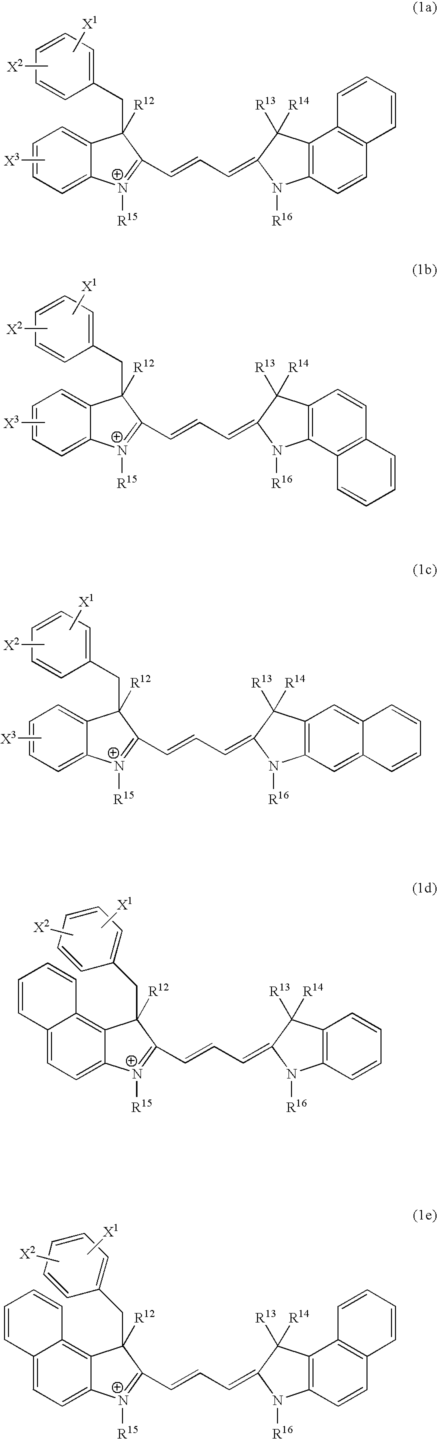

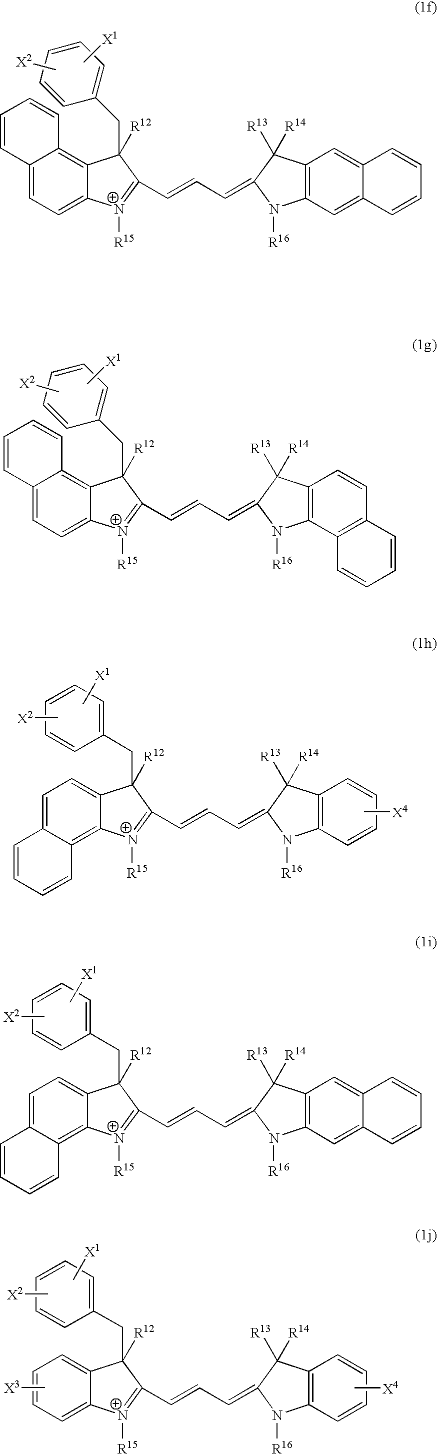

In formulas (1a) to (1j), R¹², R¹³ and R¹⁴ each independently represent a benzyl group represented by the following general formula (10) or a C1-C4 alkyl group, X¹ and X² each independently represent a hydrogen atom, a halogen atom or a C1-C4 alkyl group (preferably a methyl group); and X³ and X⁴ each independently represent a hydrogen atom, a halogen atom or a C1-C4 alkyl group (preferably a methyl, ethyl or isopropyl group), a C1-C4 alkoxy group (preferably a methoxy group), a nitro group or a cyano group. Here, R¹³ and R¹⁴ may form a cyclopropane ring, cyclobutane ring, cyclopentane ring or cyclohexane ring by joining together.

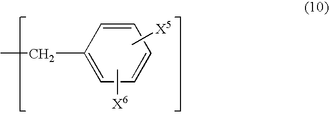

In formula (10), X⁵ and X⁶ each independently represent a hydrogen atom, a halogen atom or a C1-C4 alkyl group (preferably a methyl group). When a plurality of benzyl groups represented by formula (10) exist in the same molecule in any of formulas (1a) to (1j), they may be the same or different from each other.

More specifically, those represented by formulas of Nos. T1 to T64 shown in the following Tables 1 to 6 are preferred as the cyanine dye cation represented by formula (1).

TABLE 1

| No. | |
|---|---|
| T1 | 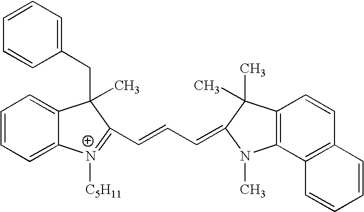 |
| T2 | 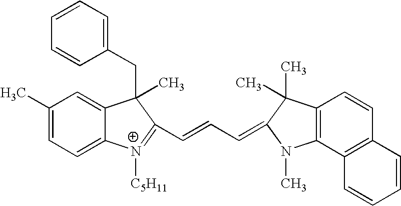 |
| T3 | 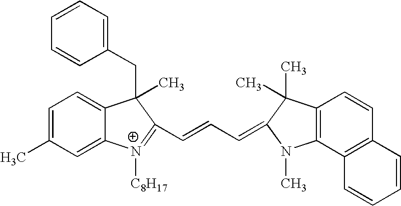 |
| T4 | 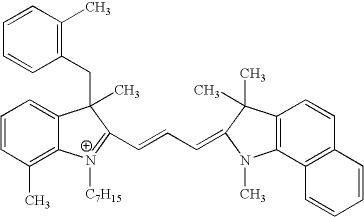 |
| T5 | 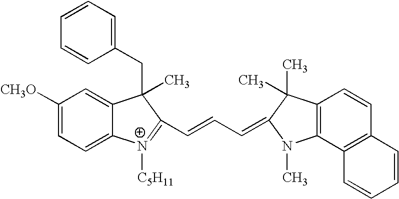 |
| T6 | 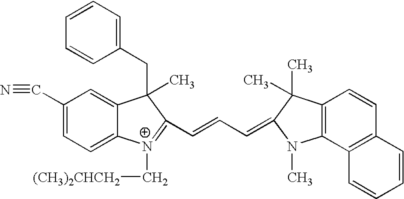 |
| T7 | 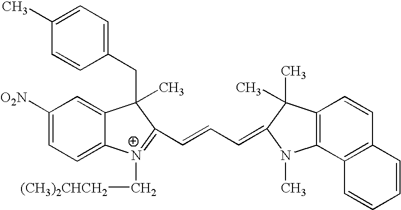 |
| T8 | 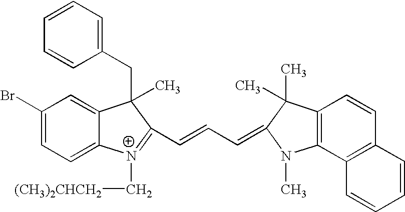 |
| T9 | 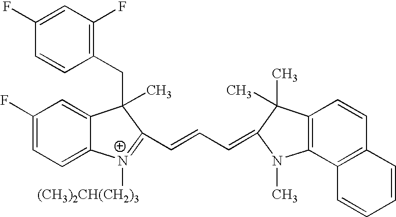 |
| T10 | 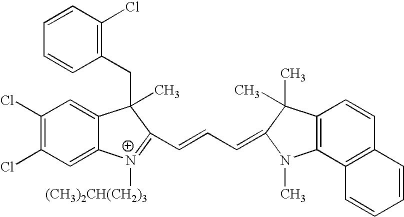 |
| T11 | 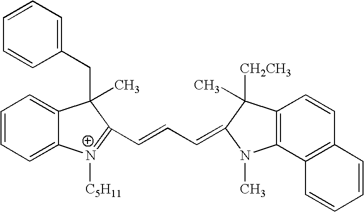 |
| T12 | 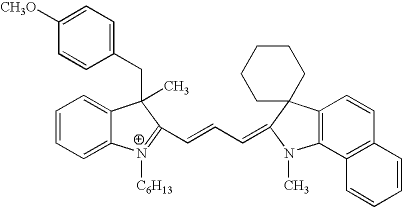 |

TABLE 2

| No. | |
|---|---|
| T13 | 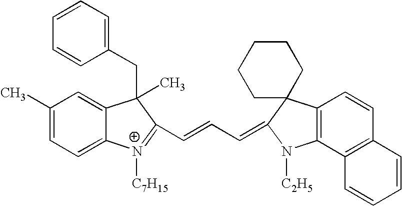 |
| T14 | 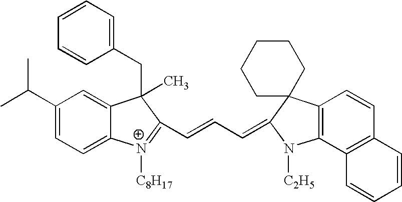 |
| T15 | 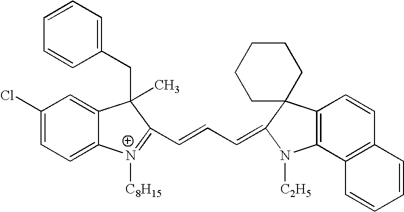 |
| T16 | 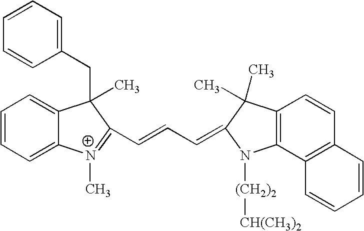 |
| T17 | 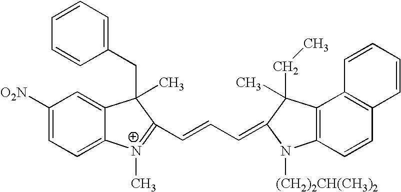 |
| T18 | 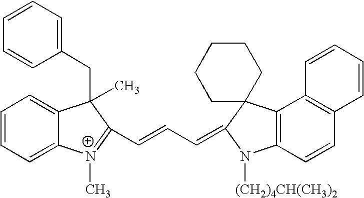 |
| T19 | 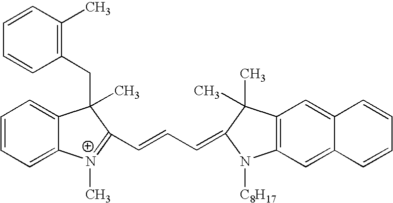 |
| T20 | 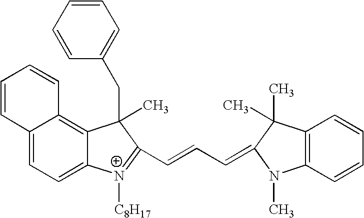 |
| T21 | 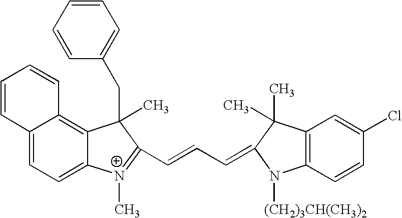 |
| T22 | 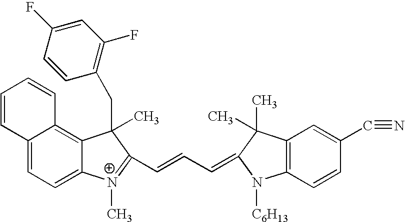 |
| T23 | 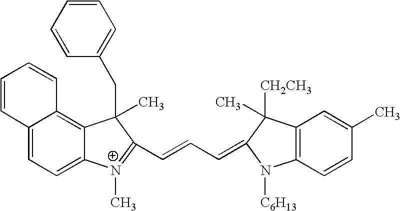 |
| T24 | 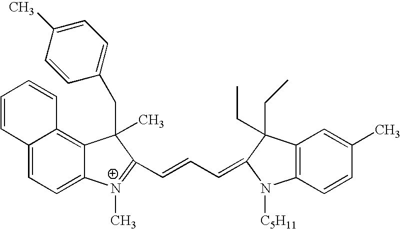 |

TABLE 3

| No. | |
|---|---|
| T25 | 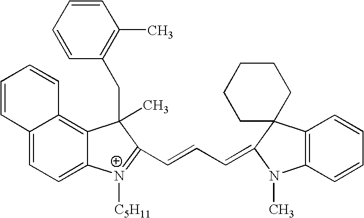 |
| T26 | 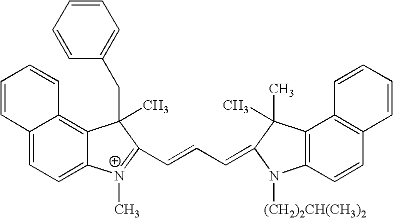 |
| T27 | 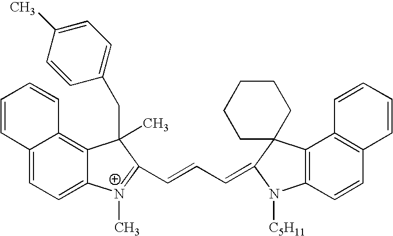 |
| T28 | 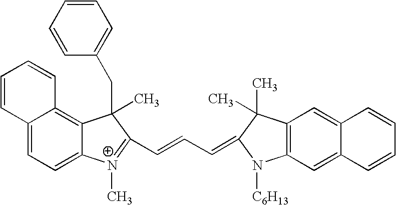 |
| T29 | 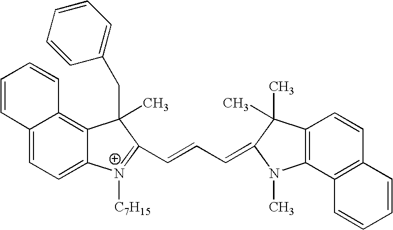 |
| T30 | 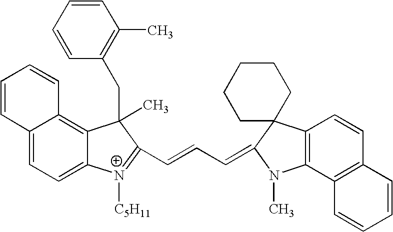 |
| T31 | 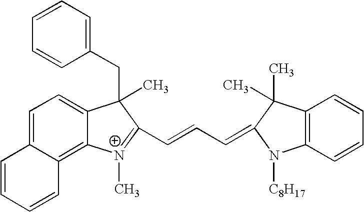 |
| T32 | 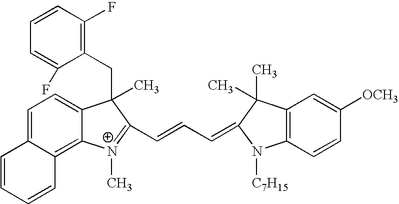 |
| T33 | 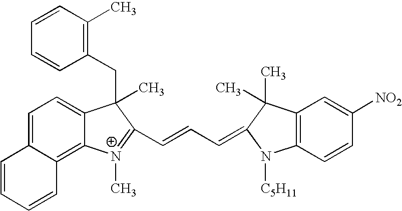 |
| T34 | 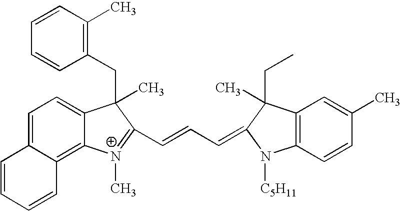 |
| T35 | 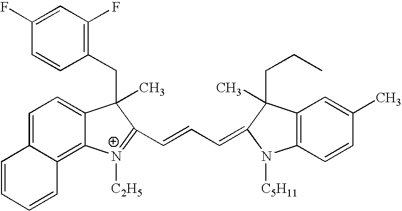 |
| T36 | 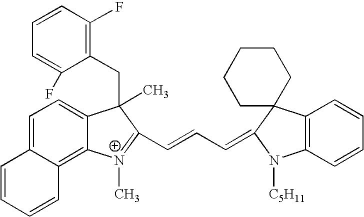 |

TABLE 4

| No. | |
|---|---|
| T37 | 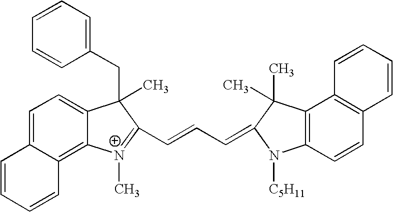 |
| T38 | 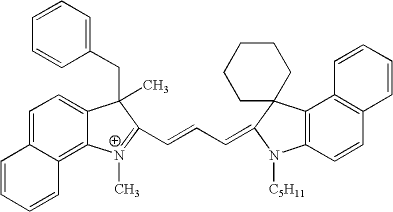 |
| T39 | 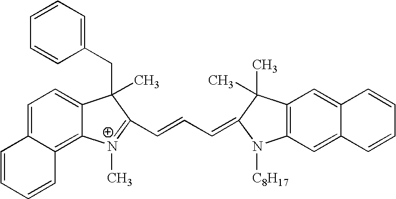 |
| T40 | 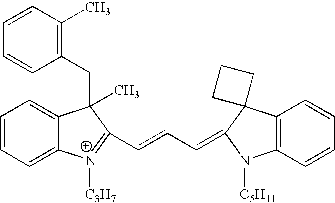 |
| T41 | 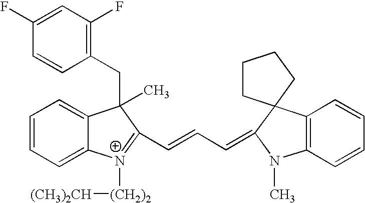 |
| T42 | 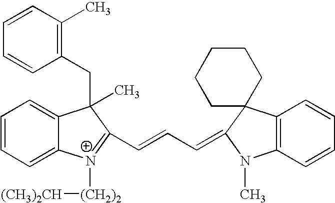 |
| T43 | 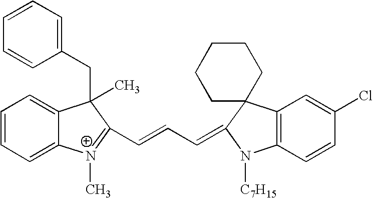 |
| T44 | 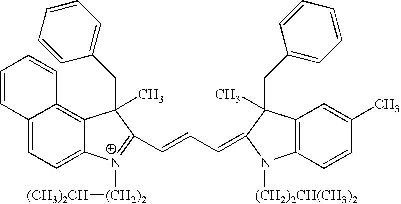 |
| T45 | 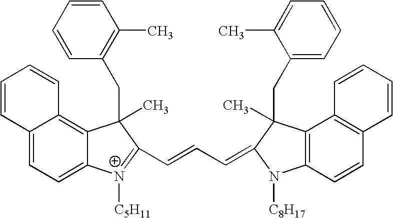 |
| T46 | 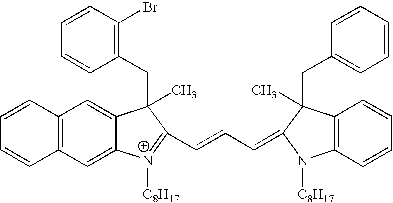 |
| T47 | 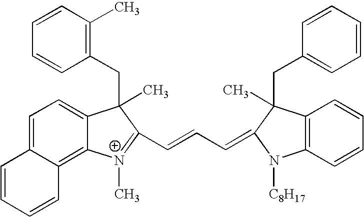 |
| T48 | 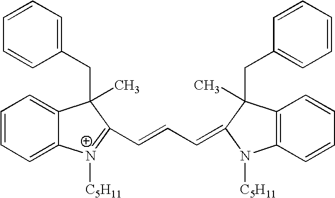 |

TABLE 5

| No. | |
|---|---|
| T49 | 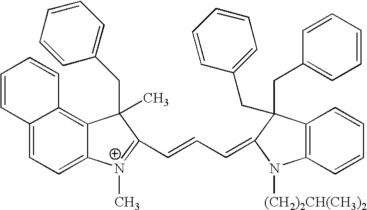 |
| T50 | 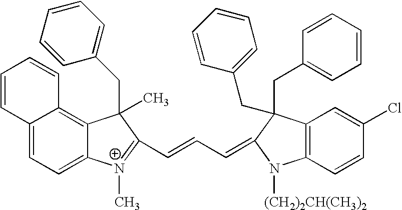 |
| T51 | 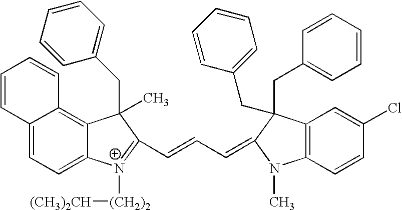 |
| T52 | 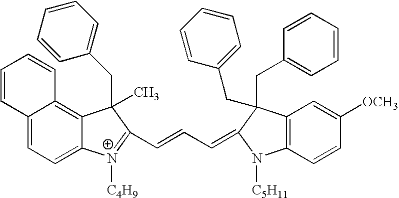 |
| T53 | 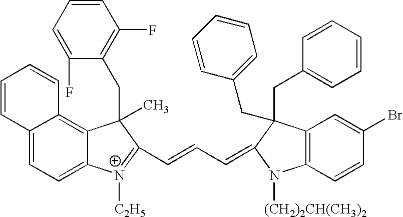 |
| T54 | 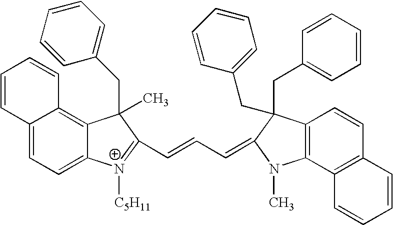 |
| T55 | 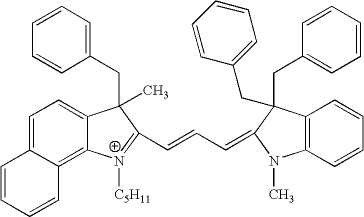 |
| T56 | 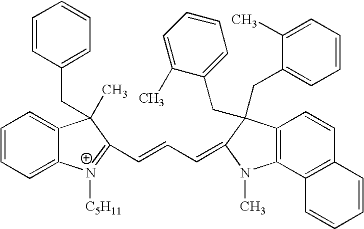 |
| T57 | 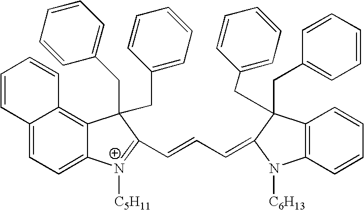 |
| T58 | 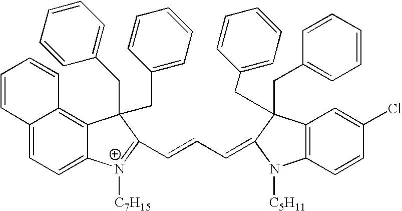 |
| T59 | 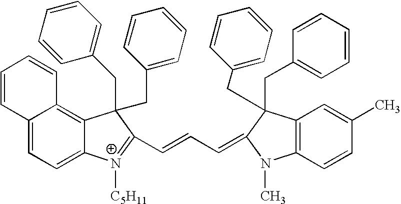 |
| T60 | 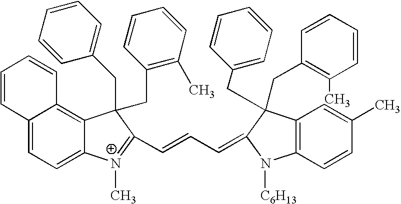 |

TABLE 6

| No. | |
|---|---|
| T61 | 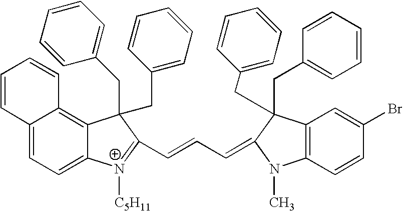 |
| T62 | 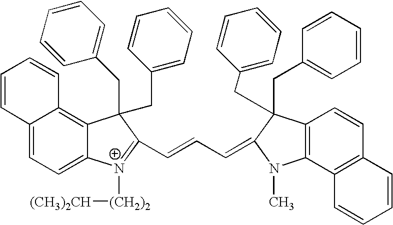 |
| T63 | 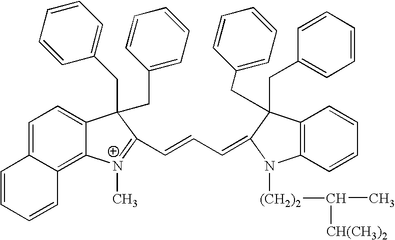 |
| T64 | 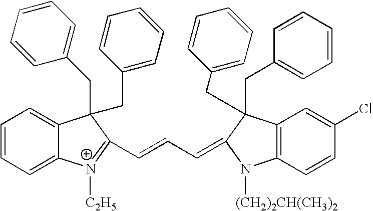 |

The foregoing cyanine dye cations are used either singly or in combination of a plurality of species. These cyanine dye cations can be obtained by synthesizing according to known methods.

The optical recording material usually contains a counteranion which neutralizes electric charges of the cyanine dye cations. Examples of the counteranion include univalent anions such as ClO₄⁻, I⁻, BF₄⁻, PF₆⁻, and SbF₆⁻. When the above-mentioned chelate compound is an anion, a salt formed by using this anion as a counteranion for the cyanine dye cation may be used. From the viewpoint of easiness in optimizing the leveling factor and the like, the optical recording material preferably contains a salt formed between the cyanine dye cation and at least one species of counteranion selected from the above-mentioned chelate compound, PF₆⁻, and SbF₆⁻, more preferably both of a salt with the above-mentioned chelate compound and a salt with PF₆⁻ or SbF₆⁻, among those mentioned above.

Here, the leveling factor is the value expressed by leveling factor C=[groove recording layer thickness DG (μm)—land part recording layer thickness DI (μm)]/groove depth A (μm). Optimizing the leveling factor yields a favorable balance between reflectance and degree of modulation with an excellent jitter characteristic. The leveling factor C in DVD+R and DVD−R is preferably 0.1 to 0.4, more preferably 0.2 to 0.3. When the leveling factor is less than 0.1, sufficient reflectance and degree of modulation tend to be harder to attain. When the leveling factor exceeds 0.4, an increase in jitter and a decrease in reflectance are more likely to occur. When the optical recording layer contains PF₆⁻ or SbF₆⁻ as an anion, the fluidity in the state of a coating liquid is improved. This makes the recording layer achieve a favorable coverage from the land part to the groove, which can reduce the difference in thickness between DG and DI.

The chelate compound is a metal chelate compound formed when an azo compound having an azo group substituted by an aromatic ring coordinates with a metal, and is also known as an azo-based dye, an azo-based colorant, etc. An example of the azo compound constituting the chelate compound is a compound represented by the following general formula (2):
Ar¹—N═N—Ar² (2)

In formula (2), Ar¹ and Ar² represent an optionally substituted aryl group, whereas one of them is an aryl group having a substituent adapted to coordinate with a metal atom or an optionally substituted aryl group constituted by a nitrogen-containing aromatic ring having a nitrogen atom adapted to coordinate with a metal atom. The substituent adapted to coordinate with a metal atom and the nitrogen atom adapted to coordinate with a metal atom are preferably located at a position (e.g., at the ortho position in a benzene ring) where they can coordinate with a metal together with an azo group.

Ar¹ and Ar² have a monocyclic or condensed polycyclic or assembled polycyclic aromatic ring. Examples of such an aromatic ring include a benzene, naphthalene, pyridine, thiazole, benzothiazole, oxazole, benzoxazole, quinoline, imidazole, pyrazine and pyrrole ring, among which a benzene, pyridine, quinoline and thiazole ring are preferred in particular.

An example of the substituent adapted to coordinate with a metal atom is a group having an active hydrogen. Examples of the group having an active hydrogen include a hydroxyl group, mercapto group, amino group, carboxyl group, carbamoyl group, optionally substituted sulfamoyl group, sulfo group and sulfonylamino group, among which a hydroxyl group, primary or secondary amino group and optionally substituted sulfamoyl group are preferred in particular. Ar¹ and Ar² may further have substituents other than those which can coordinate with metal atoms.

The substituents in Ar¹ and Ar² may be either the same or different from each other. When they differ from each other, Ar¹ preferably has at least one species selected from the group consisting of a nitro group, halogen atom (e.g., chlorine or bromine atom), carboxyl group, sulfo group, sulfamoyl group and alkyl group (preferably a C1-C4 alkyl, more preferably a methyl group), while Ar² preferably has at least one species selected from the group consisting of an amino group (preferably a dialkylamino group having a total carbon number of 2 to 8, examples of which include a dimethylamino, diethylamino, methylethylamino, methylpropylamino, dibutylamino, and hydroxyethylmethylamino group), alkoxy group (preferably having a carbon number of 1 to 4, an example of which is methoxy group), alkyl group (preferably a C1-C4 alkyl group, more preferably a methyl group), aryl group (preferably having a monocyclic ring, examples of which include phenyl or chlorophenyl group), carboxyl group, and sulfo group. When Ar¹ is an optionally substituted phenyl group, the substituent is preferably located at the meta or para position, more preferably at the meta position, with respect to the azo group.

More specifically, Ar¹ and Ar² are preferably univalent groups represented by the following formulas (20a), (20b), (20c), (20d), (20e), (20f), (20g), (20h) or (20i):

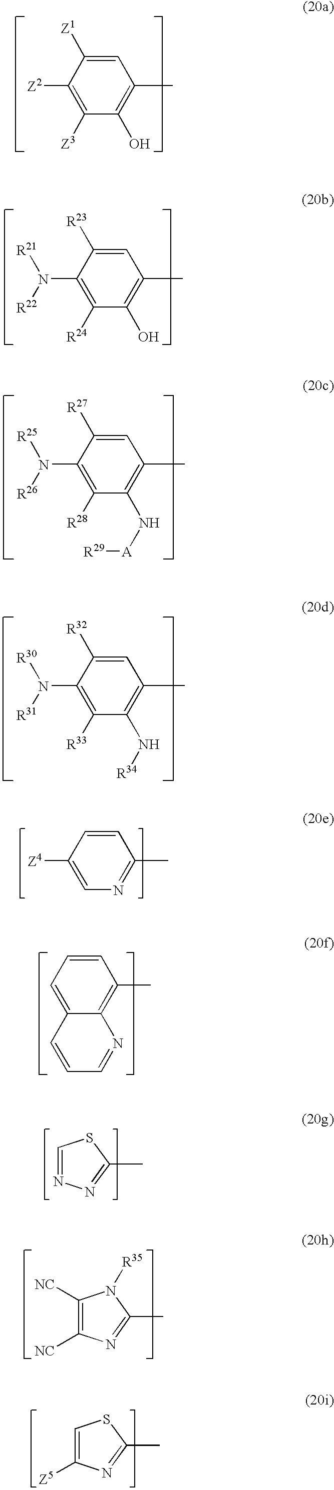

In formula (20a), Z¹, Z² and Z³ each independently represent a hydrogen atom, a halogen atom or a nitro group, whereas at least one of them is preferably a halogen atom or a nitro group. In formulas (20e) and (20i), Z⁴ and Z⁵ represent a hydrogen atom, a halogen atom or a nitro group, preferably a halogen atom or a nitro group.

In formula (20b), R²¹, R²², R²³ and R²⁴ each independently represent an optionally substituted C2-C8 alkyl group or an optionally substituted aryl group. R²¹ and R²³ may form a ring structure by joining together, and R²² and R²⁴ may form a ring structure by joining together.

R²⁵, R²⁶, R²⁷ and R²⁸ in formula (20c) are the same as R²¹, R²², R²³ and R²⁴ in formula (20b) including their preferred modes as well. R²⁹ represents an optionally substituted alkyl group or an optionally substituted aryl group. R²⁹ is preferably a C1-C4 alkyl group, trifluoromethyl group, pentafluoroethyl group, 2,2,2-trifluoroethyl group, optionally substituted phenyl group or optionally substituted benzyl group. A in formula (20c) is a bivalent group represented by —SO₂— or —CO—, preferably a bivalent group represented by —SO_{2—.}

R³⁰, R³¹, R³² and R³³ in formula (20d) are the same as R²¹, R²², R²³ and R²⁴ in formula (20b) including their preferred modes as well. R³⁴ represents an optionally alkyl group or an optionally substituted aryl group, preferably an optionally substituted C1-C4 alkyl group or an optionally substituted phenyl group.

Preferred specific examples of the azo compound include those represented by formulas of Nos. A1 to A63 shown in the following Tables 7 to 11.

TABLE 7

| No. | |
|---|---|
| A1 | 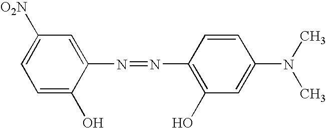 |
| A2 | 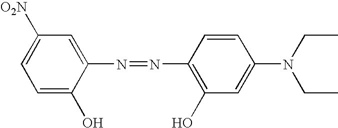 |
| A3 | 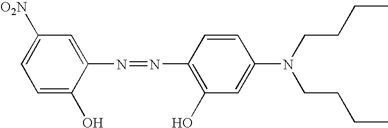 |
| A4 | 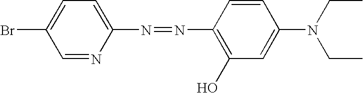 |
| A5 | 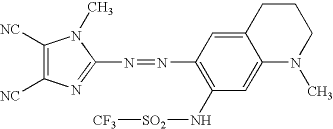 |
| A6 | 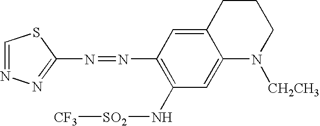 |
| A7 | 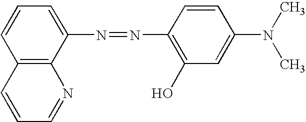 |
| A8 | 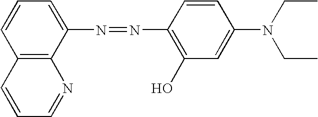 |
| A9 | 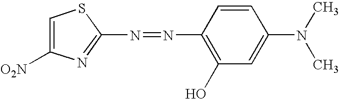 |
| A10 | 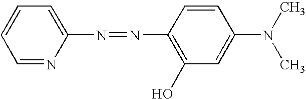 |
| A11 | 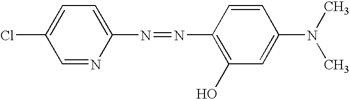 |
| A12 | 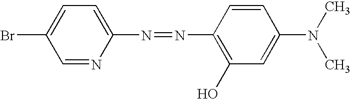 |
| A13 | 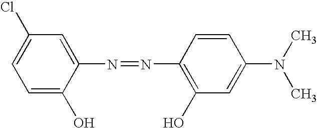 |
| A14 | 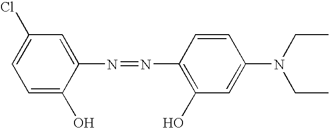 |
| A15 | 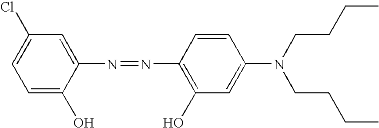 |
| A16 | 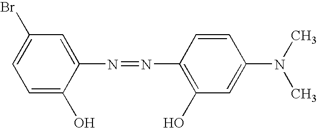 |

TABLE 8

| No. | |
|---|---|
| A17 | 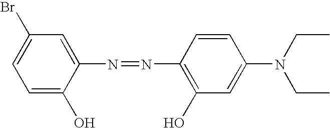 |
| A18 | 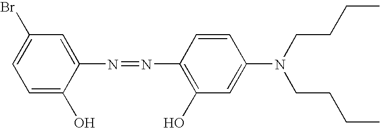 |
| A19 | 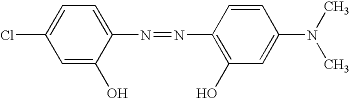 |
| A20 | 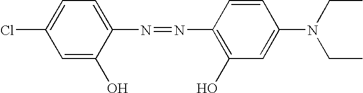 |
| A21 | 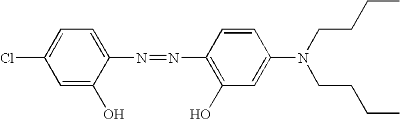 |
| A22 | 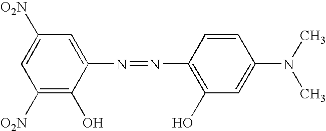 |
| A23 | 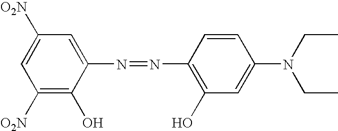 |
| A24 | 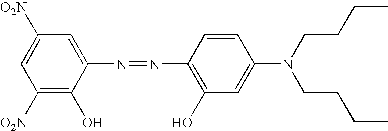 |
| A25 | 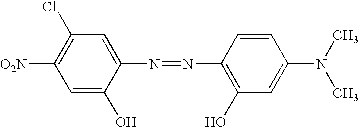 |
| A26 | 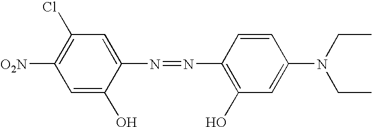 |
| A27 | 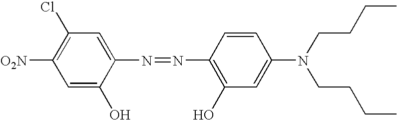 |
| A28 | 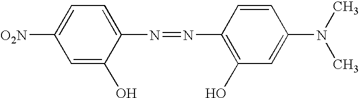 |
| A29 | 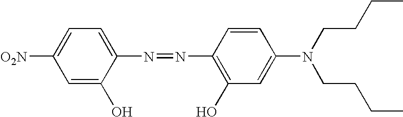 |
| A30 | 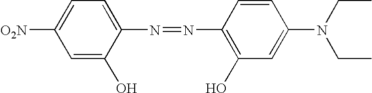 |
| A31 | 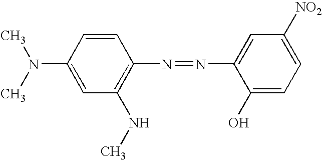 |
| A32 | 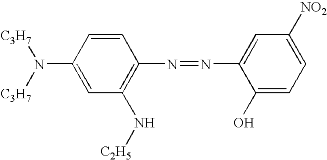 |

TABLE 9

| No. | |
|---|---|
| A33 | 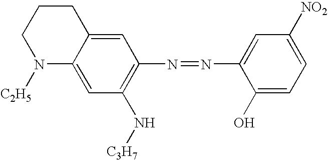 |
| A34 | 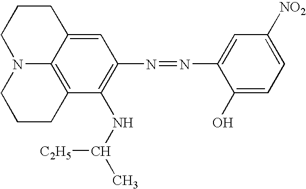 |
| A35 | 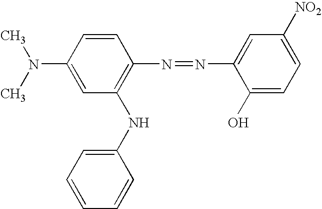 |
| A36 | 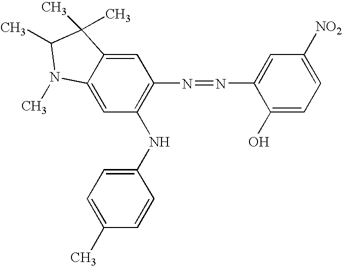 |
| A37 | 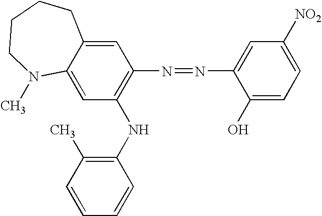 |
| A38 | 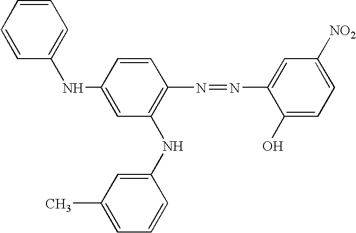 |
| A39 | 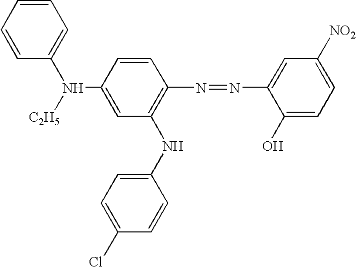 |
| A40 | 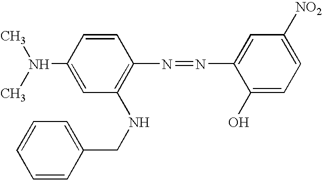 |
| A41 | 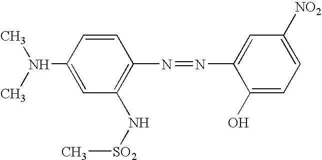 |
| A42 | 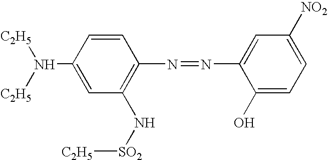 |
| A43 | 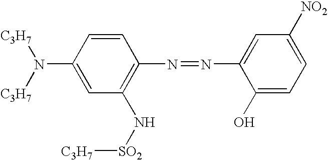 |
| A44 | 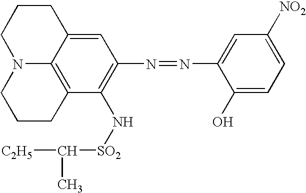 |

TABLE 10

| No. | |
|---|---|
| A45 | 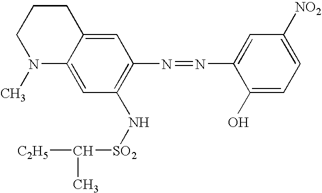 |
| A46 | 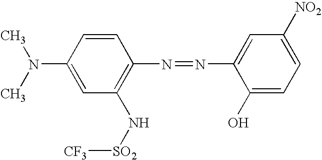 |
| A47 | 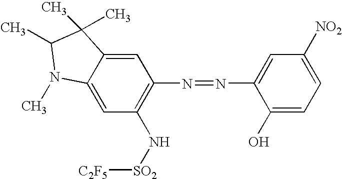 |
| A48 | 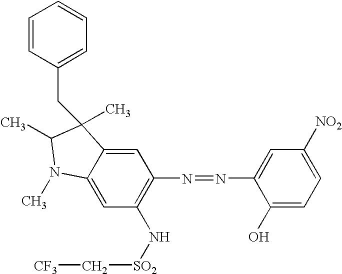 |
| A49 | 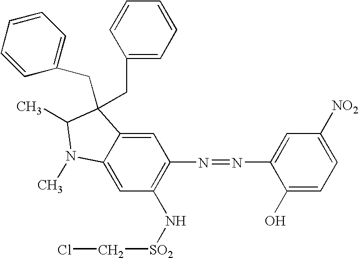 |
| A50 | 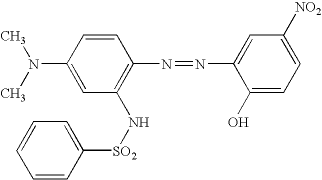 |
| A51 | 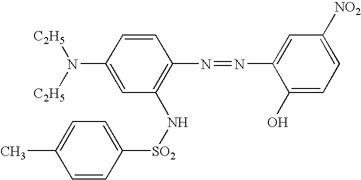 |
| A52 | 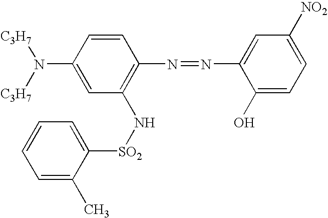 |
| A53 | 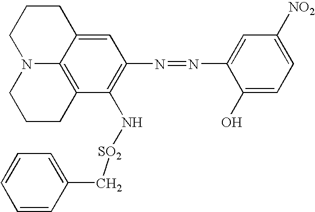 |
| A54 | 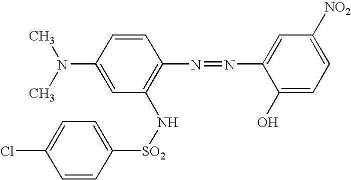 |

TABLE 11
No.

| | |
|---|---|
| A55 | 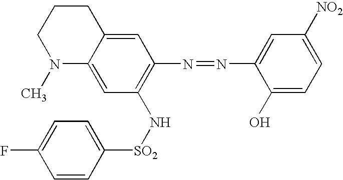 |
| A56 | 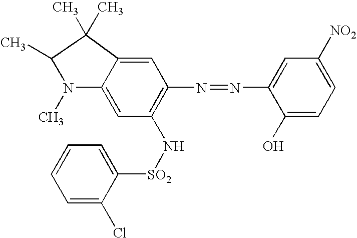 |
| A57 | 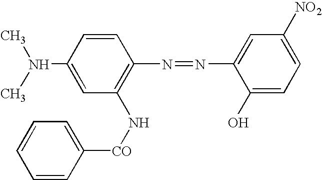 |
| A58 | 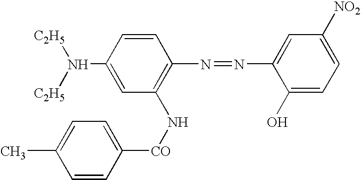 |
| A59 | 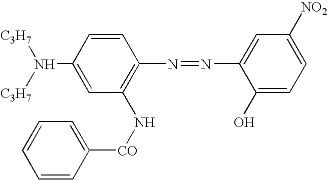 |
| A60 | 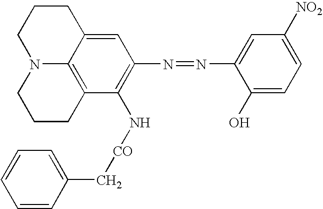 |
| A61 | 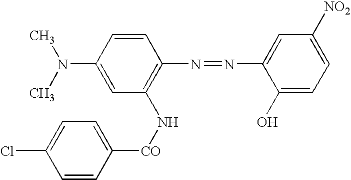 |
| A62 | 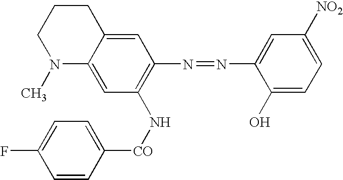 |
| A63 | 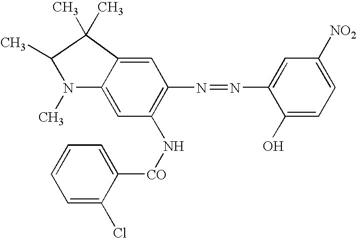 |

Preferred as the metal (center metal) constituting the chelate compound are transition metals such as Co, Mn, Cr, Ti, V, Ni, Cu, Zn, Mo, W, Ru, Fe, Pd, Pt and Al. V, Mo and W may be included as their oxide ions such as VO²⁺, VO³⁺, MoO²⁺, MoO³⁺ and WO³⁺. Among them, VO²⁺, VO³⁺, Co, Ni and Cu are preferred in particular.

In the chelate compound, the above-mentioned azo compound usually forms a coordinate bond with a metal as a 2- or 3-site ligand. When the azo compound has a substituent including an active hydrogen, this active hydrogen is usually desorbed, so as to yield a 2- or 3-site ligand.

The chelate compound may be neutral as a whole or become an anion or cation. The chelate compound that is an anion usually forms a salt with its countercation. Examples of the countercation include metal cations such as Na⁺, Li⁺ and K⁺, ammonium and tetraalkyl ammonium. A salt may also be formed while using the above-mentioned cyanine dye cation as a countercation as mentioned above.

Preferred specific examples of the chelate compound include chelate compounds of Nos. C1 to C49 formed when the above-mentioned azo compounds coordinate with the center metals shown in Table 12. They are used singly or in combination of a plurality of species. In the chelate compounds shown in Table 12, two azo compounds coordinate with one element of a center metal. Two species each of the azo compound and center metal shown in the table are meant to be contained at a mole ratio of 1:1, whereas the center metals indicated by V═O refer to those in which the azo compounds coordinate with acetylacetone vanadium. These chelate compounds can be obtained by synthesizing according to known methods (see, for example, Furukawa, Anal. Chim. Acta., 140, p. 289, 1982).

TABLE 12

| | Azo | Center |
|---|---|---|
| No. | compound | metal |
| C1 | A1 | Co |
| C2 | A1 | V═O |
| C3 | A2 | Co |
| C4 | A2 | V═O |
| C5 | A3 | Co |
| C6 | A3 | V═O |
| C7 | A1 + A3 | Co |
| C8 | A1 + A2 | Co |
| C9 | A2 + A3 | Co |
| C10 | A1 | Co + V═O |
| C11 | A2 | Co + V═O |
| C12 | A3 | Co + V═O |
| C13 | A4 | Cu |
| C14 | A4 | Ni |
| C15 | A4 | Co |
| C16 | A5 | Ni |
| C17 | A6 | Ni |
| C18 | A7 | Co |
| C19 | A7 | Ni |
| C20 | A7 | Cu |
| C21 | A8 | Co |
| C22 | A8 | Ni |
| C23 | A8 | Cu |
| C24 | A9 | Cu |
| C25 | A9 | Ni |
| C26 | A10 | Cu |
| C27 | A10 | Ni |
| C28 | A11 | Cu |
| C29 | A11 | Ni |
| C30 | A12 | Cu |
| C31 | A12 | Ni |
| C32 | A13 | Co |
| C33 | A14 | Co |
| C34 | A15 | Co |
| C35 | A16 | Co |
| C36 | A17 | Co |
| C37 | A18 | Co |
| C38 | A19 | Co |
| C39 | A20 | Co |
| C40 | A21 | Co |
| C41 | A22 | Co |
| C42 | A23 | Co |
| C43 | A24 | Co |
| C44 | A25 | Co |
| C45 | A26 | Co |
| C46 | A27 | Co |
| C47 | A28 | Co |
| C48 | A31 | Co |
| C49 | A32 | Co |

In the optical recording material of the present invention, the content of the chelate compound is preferably 10 to 70 mol % based on the total amount of the cation and chelate compound. The content is preferably 15 to 50 mol %, more preferably 20 to 30 mol %. When the content is less than 10 mol %, optical stability tends to become insufficient. When the content exceeds 70 mol %, jitter tends to increase in optical recording media recorded at a high speed in particular.

The optical recording material containing the cation and chelate compound in such a ratio can be obtained when a mixture is formed by mixing the chelate compound with a salt made of the cation and its counteranion or when a salt (integrated salt) made of a cyanine dye cation and a chelate compound anion is formed if the chelate compound is an anion. The mixture and integrated salt may coexist as well.

The foregoing optical recording material can favorably be used for forming a recording layer of an optical recording medium of the present invention which will be explained later.

Optical Recording Material Solution

The optical recording material solution of the present invention is one in which the above-mentioned optical recording material is dissolved into a predetermined solvent which can dissolve the material. As will be explained later, this optical recording material solution is favorably used for forming a recording layer in an optical recording medium.

Examples of the solvent for the optical recording material solution include alcohol, aliphatic hydrocarbon-based solvents, ketone-based solvents, ester-based solvents, ether-based solvents, aromatic solvents and alkyl-halide-based solvents. Preferred among them are alcohol and aliphatic hydrocarbon-based solvents.

Preferred as alcohol is fluorinated alcohol, alkoxy alcohol and keto alcohol. Fluorinated alcohol is preferred in particular when forming a recording layer on a polycarbonate substrate.

Preferred as fluorinated alcohol is alkyl alcohol substituted by at least one fluorine atom, such as 2,2,3,3-tetrafluoropropanol (TFP) and 2,2,3,3,4,4,5,5-octafluoro-1-pentanol (OFP) in particular. These kinds of fluorinated alcohol are used singly or in combination of a plurality of species. They may be used together with other kinds of alcohol as well.

In alkoxy alcohol, its alkoxy part preferably has a carbon number of 1 to 4, while its alcohol part preferably has a carbon number of 1 to 5, more preferably 2 to 5. The total carbon number of alkoxy alcohol is preferably 3 to 7. Specific examples of alkoxy alcohol include ethylene glycol monoalkyl ethers (cellosolves) such as ethylene glycol monomethyl ether (methyl cellosolve), ethylene glycol monoethyl ether (ethyl cellosolve, also known as ethoxyethanol), butyl cello solve and 2-isopropoxy-1-ethanol, 1 -methoxy-2-propanol, 1-methoxy-2-butanol, 3-methoxy-1-butanol, 4-methoxy-1-butanol, and 1-ethoxy-2-propanol. An example of keto alcohol is diacetone alcohol.

Preferred as the aliphatic hydrocarbon-based solvents are n-hexane, cyclohexane, methylcyclohexane, ethylcyclohexane, cyclooctane, dimethylcyclohexane, n-octane, iso-propylcyclohexane and t-butylcyclohexane, among which ethylcyclohexane and dimethylcyclohexane are preferred in particular. An example of the ketone-based solvents is cyclohexanone.

The optical recording material solution can be prepared by putting the optical recording material into the solvent and dissolving it by ultrasonic processing or the like while heating if necessary. The concentration of the optical recording material in the optical recording material solution is preferably 0.1 to 10 mass % based on the whole optical recording material solution. The optical recording material solution may contain binders, dispersants, stabilizers and the like, if necessary, in addition to the optical recording material and solvent.

Optical Recording Medium

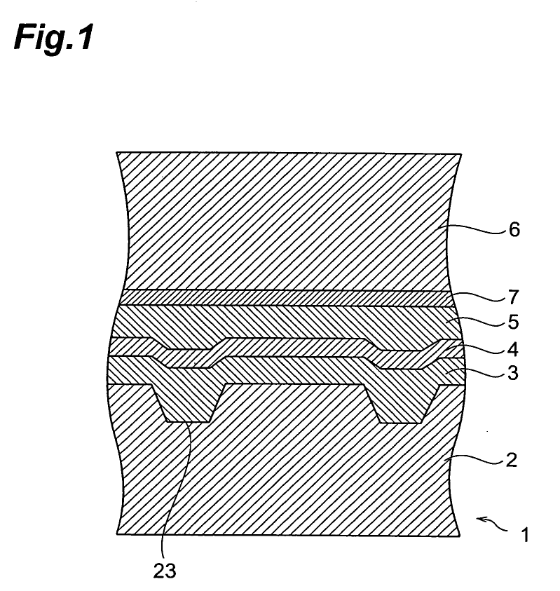

FIG. 1 is a partly sectional view showing a preferred embodiment of optical recording disk as the optical recording medium of the present invention. The optical recording disk 1 shown in FIG. 1 has a multilayer structure in which a recording layer 3, a reflecting layer 4, a protective layer 5, an adhesive layer 7 and a substrate 6 are closely mounted in this order on a substrate 2. The optical recording disk 1 is a rewritable optical recording disk which is capable of recording and reproducing with light having a short wavelength of 630 to 685 nm.

Each of the substrates 2 and 6 has a disk form with a diameter of about 64 to 200 nm and a thickness of about 0.6 mm, whereas recording and reproducing are performed from the rear side of the substrate 2 (the lower side in the drawing). Therefore, it will be preferred if at least the substrate 2 is substantially transparent to recording light and reproducing light. More specifically, the substrate 2 exhibits a transmittance of at least 88% with respect to the recording light and reproducing light. Preferred as the material for the substrate 2 are resins and glass satisfying the condition concerning the transmittance mentioned above, among which thermoplastic resins such as polycarbonate resins, acrylic resins, amorphous polyolefin, TPX, and polystyrene-based resins are preferred in particular. On the other hand, the material for the substrate 6 is not limited in particular and can be the same as the material for the substrate 2, for example.

The surface formed with the recording layer 3 in the substrate 2 is formed with a groove 23 which is a groove for tracking. The groove 23 is preferably a spiral continuous groove and preferably has a depth of 80 to 250 nm, a width of 200 to 500 nm, and a groove pitch of 600 to 1,000 nm. The groove having such a configuration can yield a favorable tracking signal without lowering the reflection level of the groove. The groove 23 can be formed simultaneously when the substrate 2 is formed by injection molding or the like using the above-mentioned resins. Alternatively, a resin layer having the groove 23 may be formed by the 2P method or the like after making the substrate 2, so as to yield a composite substrate constituted by the resulting resin layer and the substrate 2.

The recording layer 3 contains the optical recording material of the present invention, and is formed by using the optical recording material solution of the present invention, for example. In this case, after the step of forming a solution layer made of the optical recording material solution onto the substrate 2, the solvent is removed from within the solution layer, so as to form the recording layer 3 containing the optical recording material.

The solution layer is formed by being applied onto the substrate 2 by a method such as spin coating, gravure coating, spray coating and dip coating. Among them, spin coating is preferred.

Subsequently, the solution layer is dried by being left at room temperature or heating if necessary, whereby a part of the solvent is removed therefrom. Here, it will be preferred if the recording layer 3 is heated such that a solvent such as fluorinated alcohol remains therein by about 3 mass % or less (preferably 0.05 to 2 mass %) of the whole recording layer 3. When the solvent such as fluorinated alcohol remains in the recording layer 3 within the above-mentioned range, the recording layer 3 exhibits an appropriate viscosity (fluidity). As a consequence, even when the recording layer 3 deforms along with minute deflections upon handling the optical recording medium, the recording layer 3 restores itself when the optical recording medium recovers from the deflected state, whereby recording functions are resumed. When the solvent remains by 3 mass % or more of the whole recording layer 3, dye molecules tend to move easily, whereby partial crystallization is easier to occur. When the solvent such as fluorinated alcohol is completely removed from within the recording layer 3, the recording layer 3 tends to lower its viscosity remarkably, whereby the self-restoring function mentioned above may be lost.

The thickness of the recording layer 3 is preferably 50 to 200 nm. The thickness of 70 to 150 nm is more preferred, since it yields a better balance between the degree of modulation and reflectance. On the outside of such a range, the reflectance tends to decrease, thereby making it harder to perform reproducing. When the recording layer 3 has a thickness of 200 nm or greater in a part adjacent to the groove 23, the balance between the degree of modulation and reflection tends to deteriorate.

The recording layer 3 preferably exhibits an extinction coefficient (imaginary part k of complex refractive index) of 0 to 0.20 with respect to the recording light and reproducing light. The extinction coefficient exceeding 0.20 is less likely to yield a sufficient reflectance. The recording layer 3 preferably has a refractive index (real part n of complex refractive index) of 1.8 or greater. When the refractive index is less than 1.8, the degree of modulation tends to become smaller. Though not limited in particular, the upper limit of the refractive index is usually about 2.6 for the sake of synthesis of organic dyes.

The extinction coefficient and refractive index of the recording layer 3 can be determined according to the following procedure. A recording layer is initially formed on a predetermined transparent substrate by a thickness of about 40 to 100 nm, so as to make a measurement sample, whose reflectance through the substrate or from the recording layer side is then measured. In this case, the reflectance is measured by specular reflection (about 5°) using the wavelength of recording/reproducing light. Further, the transmittance of the sample is measured. From thus measured values, the extinction coefficient and refractive index can be calculated according to the method described in Ishiguro, Kozo, “Optics”, Kyoritsu Zensho, pp. 168-178, for example.

The reflecting layer 4 is provided on the recording layer 3 so as to be in close contact therewith. The reflecting layer 4 can be formed by vapor deposition, sputtering, or the like with a metal or alloy exhibiting a high reflectance. Examples of the metal and alloy include gold (Au), copper (Cu), aluminum (Al), silver (Ag) and AgCu. Thus formed reflecting layer 4 preferably has a thickness of 10 to 300 nm.

The protective layer 5 is provided on the reflecting layer 4 so as 5 to be in close contact therewith. The protective layer 5 may be formed like a layer or sheet, and can be formed, for example, by applying a coating liquid containing a material such as UV-curable resin onto the reflecting layer 4 and then drying the applied film if necessary. Spin coating, gravure coating, spray coating, dip coating, and the like can be employed at the time of coating. Thus formed protective layer 5 preferably has a thickness of 0.5 to 100 μm.

Further, the substrate 6 is provided on the protective layer 5 with the adhesive layer 7 interposed therebetween. The substrate 6 may be the same as the substrate 2 in terms of the material and thickness. Using a hot-melt adhesive, UV-curable adhesive, thermosetting adhesive, pressure sensitive adhesive, and the like, the adhesive layer 7 can be formed by their suitable methods such as roll coater, screen printing, and spin coating. In the case of DVD-R, it will be preferred if the adhesive layer 7 is formed by screen printing or spin coating using a UV-curable adhesive from the viewpoint of the balance among workability, productivity, disk characteristics and the like. The thickness of the adhesive layer 7 is preferably about 10 to 200 μm.

For recording or rewriting, thus configured optical recording disk is irradiated pulsewise with recording light having a predetermined wavelength from the rear face of the substrate 2, so as to change the optical reflectance of the irradiated part. Here, the optical recording disk 1 provided with the recording layer 3 containing the cyanine dye cation and chelate compound as a dye can achieve high levels of sensitivity, jitter, and optical stability with a favorable balance even when information is recorded/reproduced at high-speed rotations with recording/reproducing light having a short wavelength.

Though the above-mentioned embodiment relates to an optical recording disk comprising one recording layer 3 as a recording layer, a plurality of recording layers may be provided while including respective dyes different from each other. This allows a plurality of recording light beams or reproducing light beams having the same or different wavelengths to record and reproduce information. In this case, semitransparent reflecting films which are semitransparent to the respective wavelengths of recording light beams and reproducing light beams may be provided on surfaces of the recording layers which are opposite from their light entrance faces.

Two of thus obtained optical recording disks 1 or one such optical recording disk 1 and another optical recording disk having a layer structure different from that of the former optical recording disk 1 may be bonded together such that their light entrance faces (substrates 2) are on the outer side and so forth for use.

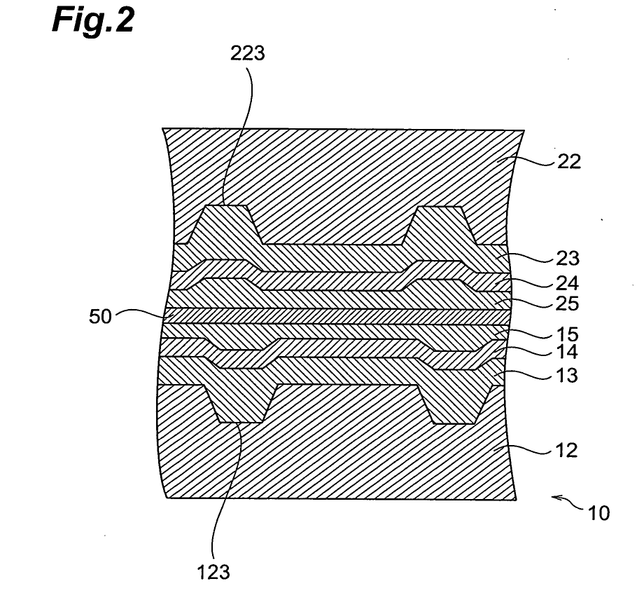

FIG. 2 is a partly sectional view showing a preferred embodiment of optical recording disk in the bonded mode mentioned above. The optical recording disk 10 shown in FIG. 2 has a structure in which a substrate 12, a recording layer 13, a reflecting layer 14, a protective layer 15, an adhesive layer 50, a protective layer 25, a reflecting layer 24, a recording layer 23, and a substrate 22 are laminated in this order. Namely, the optical recording disk 10 has a configuration in which two optical recording disks each having the same structure as that of the optical recording disk 1 are bonded together such that their protective layers oppose each other with the adhesive layer 50 similar to the adhesive layer 7 interposed therebetween. The optical recording disk 10 is a rewritable digital video disk conforming to the DVD standard, and performs recording/reproducing with light having a short wavelength of 650 to 670 nm.

The substrates 12 and 22, recording layers 13 and 23, reflecting layers 14 and 24, and protective layers 15 and 25 are formed by the same materials and methods as those in the optical recording disk 1 shown in FIG. 1. Each of the substrates 12 and 22 preferably has a thickness of about 0.6 mm. The surface formed with the recording layer 13 in the substrate 12 and the surface formed with the recording layer 23 in the substrate 22 are formed with grooves 123 and 223, respectively. Each of the grooves 123 and 223 preferably has a depth of 60 to 200 nm, a width of 200 to 500 nm, and a groove pitch of 600 to 1,000 nm. Each of the recording layers 13 and 23 preferably has a thickness of 50 to 600 nm and exhibits a complex refractive index of n=1.8 to 2.6 and k=0.00 to 0.10 with respect to light having a wavelength of 650 nm.

### EXAMPLES

In the following, the present invention will be explained more specifically with reference to examples and comparative examples. However, the present invention is not limited to the following examples.

### Example 1

Crystallization Test

A cyanine dye (A) constituted by a salt formed between a cyanine dye cation (No. T21) and a chelate compound (No. C3) was mixed with a cyanine dye (B) constituted by a salt formed between the cyanine dye cation (No. T21) and PF₆⁻ at a mole ratio of 7:3, so as to prepare an optical recording material. This optical recording material and TFP as a solvent were put into a 100-mL sample bottle made of glass in such a ratio that the optical recording material attained a concentration of 2 mass %. They were subsequently subjected to 1 hour of ultrasonic processing while being heated to 60° C., whereby an optical recording material solution having dissolved the optical recording material therein was obtained.

Thus obtained optical recording material solution was filtered through a 0.2-μm membrane filter, and then the filtrate was kept in a sample bottle made of glass in a room at a temperature of 25° C., while the state of precipitation of crystals was observed every day. For the state of precipitation of crystals, one droplet of the optical recording material solution taken out of the sample bottle was caused to fall on a polycarbonate substrate, and it was determined whether or not there was a defect in the resulting film dried at a rotating speed of 1,000 rpm with a table spinner. The defect occurring in the film was caused by crystals in the optical recording material solution, and the number of days elapsed until at least one defect was seen was defined as the number of days to crystallization. As a result of this test, the number of days to crystallization was more than 30 in the optical recording material of Example 1, whereby a practically sufficient storage stability was exhibited.

Making and Evaluation of Optical Recording Disk

An optical recording material solution in which the optical recording material had been dissolved in TFP by a concentration of 1.0 mass % was applied onto a polycarbonate resin substrate having one surface formed with a pregroove (having a depth of 0.13 μm, a width of 0.33 μm, and a groove pitch of 0.74 μm), so as to form a solution layer, which was then dried to form a recording layer (with a thickness of 130 nm). Subsequently, an Ag reflecting layer (with a thickness of 85 nm) was formed by sputtering on the recording layer, and a transparent protective layer (with a thickness of 5 μm) made of a UV-curable acrylic resin was formed on the Ag reflecting layer, so as to yield a multilayer structure. Further, two such multilayer structures were bonded together with an adhesive such that their protective layers were on the inside, so as to make an optical recording disk having the same structure as that of the optical recording disk 10 shown in FIG. 2. Out of 100 optical recording disks made in the same manner, 99 were nondefective, thus exhibiting a very high yield.

Signals were recorded onto thus obtained optical recording disks at linear velocities of 3.5 m/s (corresponding to 1× speed) and 28.0 m/s (corresponding to 8× speed) with laser light having a wavelength of 655 nm, and then jitter was measured at the time of reproducing at a linear velocity of 3.5 m/s with laser light having a wavelength of 650 nm. Here, the lens aperture was at an NA of 0.60. The optical recording disks were further irradiated (exposed to light) with a xenon lamp (Xenon Fade Meter manufactured by Shimadzu Corporation) at 80,000 lux for 40 hours. For the optical recording disks after the irradiation, jitter was measured as mentioned above, and their optical stability was evaluated. As a result, both before and after the irradiation with light, the values of jitter satisfied the standard and were favorable.

TABLE 13

| | Cyanine dye(A) | | Cyanine dye(B) | | | | |
|---|---|---|---|---|---|---|---|
| | Cyanine | | Cyanine | | (A):(B) | | |
| | dye | Chelate | dye | | (moler | | Days to |
| | cation | compound | cation | Counterion | ratio) | Solvent | crystallization |
| Ex. 1 | T21 | C3 | T21 | PF₆⁻ | 7:3 | TFP | >30 |
| Ex. 2 | T21 | C3 | T50 | PF₆⁻ | 7:3 | TFP | >30 |
| Ex. 3 | T25 | C3 | T50 | PF₆⁻ | 8:2 | TFP | >30 |
| Ex. 4 | T50 | C3 | T50 | PF₆⁻ | 6:4 | TFP | >30 |
| Ex. 5 | T51 | C3 | T51 | PF₆⁻ | 6:4 | TFP | >30 |
| Ex. 6 | T50 | C5 | T51 | PF₆⁻ | 7:3 | TFP | >30 |
| Ex. 7 | T50 | C5 | T57 | PF₆⁻ | 5:5 | TFP | >30 |
| Ex. 8 | T51 | C9 | T50 | PF₆⁻ | 4:6 | TFP | >30 |
| Ex. 9 | T52 | C15 | T51 | PF₆⁻ | 5:5 | TFP | >30 |
| Ex. 10 | T57 | C32 | T52 | PF₆⁻ | 7:3 | TFP | >30 |
| Ex. 11 | T57 | C32 | T51 | PF₆⁻ | 6:4 | OFP | >30 |
| Ex. 12 | T57 | C35 | T51 | PF₆⁻ | 7:3 | TFP | >30 |
| Ex. 13 | T57 | C35 | T57 | PF₆⁻ | 8:2 | TFP | >30 |
| Ex. 14 | T57 | C48 | T62 | PF₆⁻ | 9:1 | TFP | >30 |
| Ex. 15 | T50 | C49 | — | — | 10:0 | OFP | >30 |
| Ex. 16 | T62 | C3 | T50 | BF₄⁻ | 7:3 | OFP | >30 |
| Ex. 17 | T62 | C3 | T51 | CIO₄⁻ | 3:7 | TFP | >30 |
| Ex. 18 | T62 | C3 | T52 | BF₄⁻ | 1:9 | OFP | >30 |
| Ex. 19 | T62 | C5 | T57 | PF₆⁻ | 6:4 | OFP | >30 |
| Ex. 20 | T62 | C5 | T62 | CIO₄⁻ | 5:5 | TFP | >30 |
| Comp. | (41) | C1 | (42) | PF₆⁻ | 7:3 | TFP | 7 |
| EX. 1 | | | | | | | |
| Comp. | (43) | C3 | (44) | PF₆⁻ | 6:4 | TFP | 10 |
| EX. 2 | | | | | | | |
| Comp. | (45) | C3 | (46) | BF₄⁻ | 6:4 | OFP | 3 |
| EX. 3 | | | | | | | |
| Comp. | (47) | C8 | (48) | PF₆⁻ | 5:5 | TFP | 5 |
| EX. 4 | | | | | | | |
| Comp. | (49) | (51) | (50) | PF₆⁻ | 6:4 | TFP | 9 |
| EX. 5 | | | | | | | |

### Examples 2 to 20

Using optical recording materials with the combinations and mixing ratios of dyes shown in Table 13, the crystallization test, making of optical recording disks, and their evaluations were performed as in Example 1 except that OFP was used as a solvent when appropriate. As a result, the number of days to crystallization exceeded 30 in each of them, while their jitter values satisfied the standard and were favorable both before and after irradiation with light. The optical recording disks exhibited a yield of 98% or more in each case. In Table 13, the numbers of cyanine dye cations and chelate compounds correspond to Nos. shown in Tables 1 to 7 and 12.

### Comparative Example 1

A salt formed between the cation of the following chemical formula (41) and a chelate compound (No. C1), as a cyanine dye (A), and a salt formed between the cation of the following chemical formula (42) and PF₆⁻, as a cyanine dye (B), were mixed at a mole ratio of 7:3, so as to prepare an optical recording material. The crystallization test, making of optical recording disks, and their evaluations were performed as in Example 1 except that this optical recording material was used. Though the jitter of optical recording disks was favorable, the number of days to crystallization was 7, which was short. The yield of optical disks was 80% or less, which was not sufficient in terms of productivity.

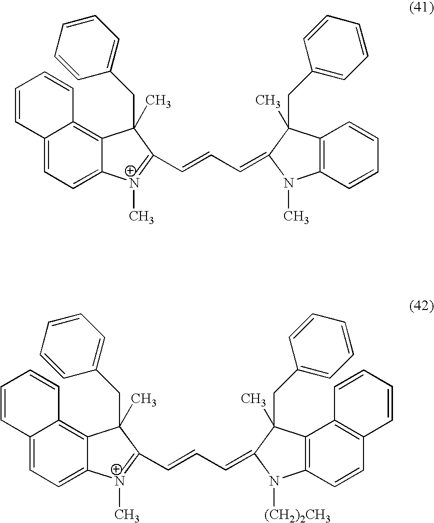

### Comparative Example 2

A salt formed between the cation of the following chemical formula (43) and a chelate compound (No. C3), as a cyanine dye (A), and a salt formed between the cation of the following chemical formula (44) and PF₆⁻, as a cyanine dye (B), were mixed at a mole ratio of 6:4, so as to prepare an optical recording material. The crystallization test, making of optical recording disks, and their evaluations were performed as in Example 1 except that this optical recording material was used. Though the jitter of optical recording disks was favorable, the number of days to crystallization was 10, which was short. The yield of optical disks was 80% or less, which was not sufficient in terms of productivity.

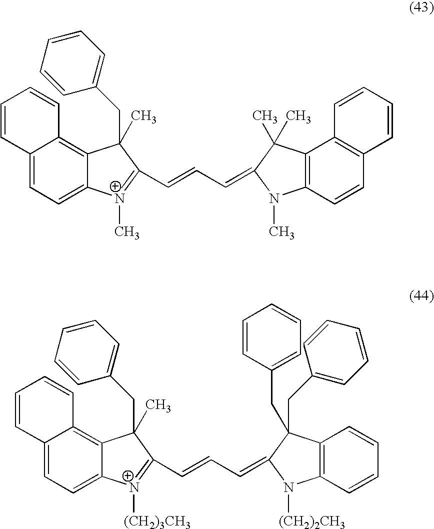

### Comparative Example 3

A salt formed between the cation of the following chemical formula (45) and a chelate compound (No. C3), as a cyanine dye (A), and a salt formed between the cation of the following chemical formula (46) and BF₄⁻, as a cyanine dye (B), were mixed at a mole ratio of 6:4, so as to prepare an optical recording material. The crystallization test, making of optical recording disks, and their evaluations were performed as in Example 1 except that this optical recording material was used. Though the jitter of optical recording disks was favorable, the number of days to crystallization was 3, which was short. The yield of optical disks was 80% or less, which was not sufficient in terms of productivity.

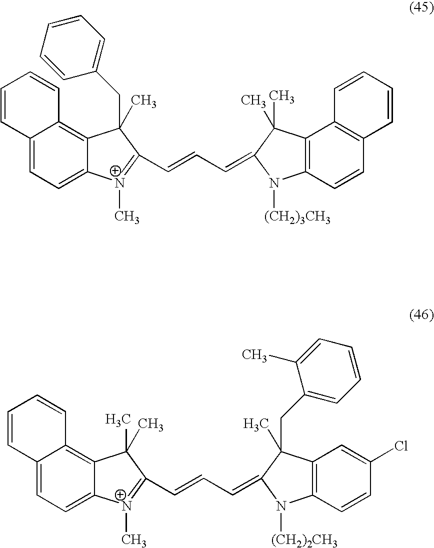

### Comparative Example 4

A salt formed between the cation of the following chemical formula (47) and a chelate compound (No. C8), as a cyanine dye (A), and a salt formed between the cation of the following chemical formula (48) and PF₆⁻, as a cyanine dye (B), were mixed at a mole ratio of 5:5, so as to prepare an optical recording material. The crystallization test, making of optical recording disks, and their evaluations were performed as in Example 1 except that this optical recording material was used. The jitter of optical recording disks was inferior and unsatisfactory in the case of recording at 8× speed in particular, whereas the number of days to crystallization was 5. The yield of optical disks was 80% or less, which was not sufficient in terms of productivity.

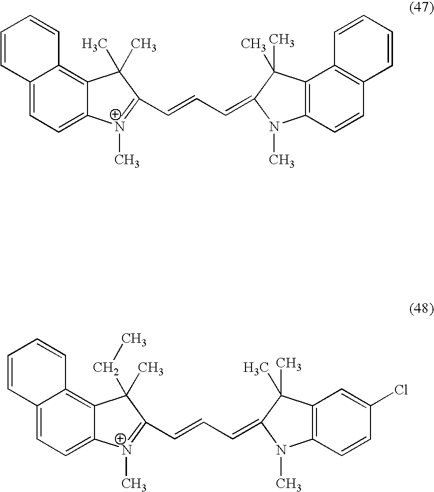

### Comparative Example 5

A salt formed between the cation of the following chemical formula (49) and the chelate compound of the following chemical formula (51), as a cyanine dye (A), and a salt formed between the cation of the following chemical formula (50) and PF₆⁻, as a cyanine dye (B), were mixed at a mole ratio of 6:4, so as to prepare an optical recording material. The crystallization test, making of optical recording disks, and their evaluations were performed as in Example 1 except that this optical recording material was used. The jitter of optical recording disks was inferior and unsatisfactory in the case of recording at 8× speed in particular, whereas the number of days to crystallization was 9. The yield of optical disks was 80% or less, which was not sufficient in terms of productivity.

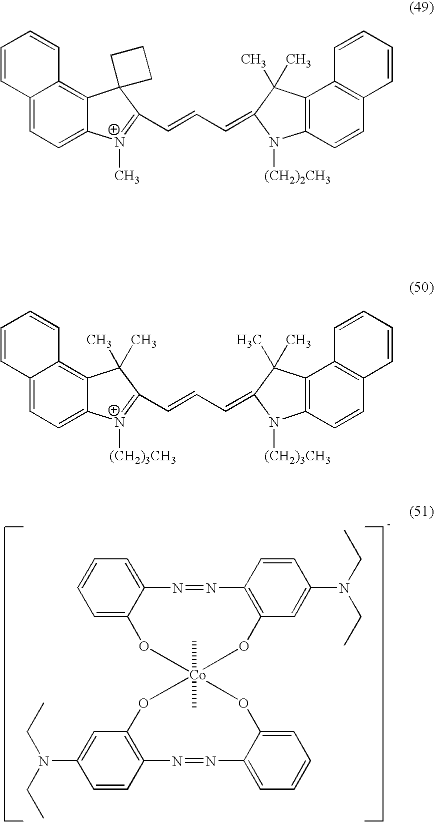

As can be seen from the foregoing results, it has been verified that Examples 1 to 20 using a cyanine dye cation which has an alkyl group with a carbon number of at least 5 at the position of a nitrogen atom and at least one benzyl group exhibit sufficient levels of sensitivity, jitter, and optical stability at a high recording speed and suppress crystallization in an optical recording material solution.

The present invention provides an optical recording material which exhibits sufficient levels of sensitivity, jitter, and optical stability at a high recording speed and a sufficient storage stability in the state of an optical recording material solution as being dissolved in a solvent.

What is claimed is:

1. An optical recording material for an optical recording medium capable of recording information by irradiation of light including:
a cation represented by the following general formula (1); and
a chelate compound formed by an azo compound and a metal, 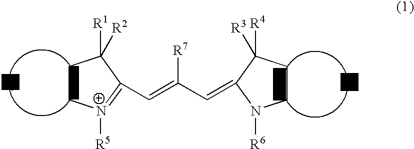
wherein
R¹, R², R³ and R⁴ each independently represent a C1-C4 alkyl group or an optionally substituted benzyl group;
R⁵ and R⁶ each independently represent an optionally substituted alkyl group or an optionally substituted aryl group;
R⁷ represents a hydrogen atom, a halogen atom, a cyano group, an optionally substituted alkyl group or an optionally substituted aryl group; and
Q¹ and Q² each independently represent a group of atoms constituting an optionally substituted aromatic ring;
with the proviso that at least one of R¹, R², R³ and R⁴ is an optionally substituted benzyl group, R¹ and R² may form a ring structure by joining together, R³ and R⁴ may form a ring structure by joining together, and at least one of R⁵ and R⁶ is an optionally substituted alkyl group having a carbon number of at least 5 or an optionally substituted aryl group having a carbon number of at least 5.

2. An optical recording material solution comprising:
a solvent including fluorinated alcohol; and
an optical recording material according to claim 1 dissolved in the solvent.

3. A method of manufacturing an optical recording medium comprising the steps of:
forming a solution layer made of an optical recording material solution according to claim 2 on a substrate; and
removing the solvent from within the solution layer, so as to form a recording layer containing the optical recording material.

4. An optical recording medium comprising a recording layer containing an optical recording material according to claim 1.

5. An optical recording medium according to claim 4, wherein the recording layer contains fluorinated alcohol.
